(19) United States
(12) Patent Application Publication
(10) Pub. No.: US 2024/0069545 A1
(43) Pub. Date: Feb. 29, 2024

(54) OPERATOR DIRECTED AUTONOMOUS SYSTEM

(71) Applicant: Agtonomy, South San Francisco, CA (US)

(72) Inventors: Timothy Bucher, Geyserville, CA (US); Nicholas Fischer, San Francisco, CA (US); David Chen, San Francisco, CA (US)

(21) Appl. No.: 18/455,269

(22) Filed: Aug. 24, 2023

Related U.S. Application Data
(60) Provisional application No. 63/373,354, filed on Aug. 24, 2022.
(60) Provisional application No. 63/484,656, filed on Feb. 13, 2023.

(51) Int. Cl. G05D 1/00

(52) U.S. Cl. CPC G05D 1/0038; G05D 1/0016; G05D 2201/0201

(57) ABSTRACT

An example method may include obtaining operational instructions for operation of an autonomous tractor system to perform an agricultural task within an operational environment and directing the operational instructions to the autonomous tractor system. The method may also include while the autonomous tractor system is autonomously performing the agricultural task per the operational instructions, obtaining a notification that the autonomous tractor system is experiencing an unexpected event. The notification may provide an indication of the event and multiple responses performable by the autonomous tractor system in response to the event. In response to the notification, the method may include obtaining, based on input from a user, a selection of one of the multiple responses and directing the selected one of the multiple responses to the autonomous tractor system.

### FIELD

The present disclosure is generally directed towards an operator directed autonomous system.

### BACKGROUND

Unless otherwise indicated herein, the materials described herein are not prior art to the claims in the present application and are not admitted to be prior art by inclusion in this section.

Farming and agricultural ventures are often associated with labor intensive work and/or time intensive operations. In some circumstances, long hours may be attributed to one or more operations performed over large tracts of land and/or crops dispersed across the land. In some instances, tractors and other large machinery may be used to reduce the amount of time a given operation may take. In circumstances where many operations are performed in a farming or agricultural venture, multiple operators may handle tractors and/or machinery to accomplish the many operations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an embodiment, a method may include obtaining operational instructions for operation of an autonomous tractor system to perform an agricultural task within an operational environment and directing the operational instructions to the autonomous tractor system. The method may also include while the autonomous tractor system is autonomously performing the agricultural task per the operational instructions, obtaining a notification that the autonomous tractor system is experiencing an unexpected event. The notification may provide an indication of the event and multiple responses performable by the autonomous tractor system in response to the event. In response to the notification, the method may include obtaining, based on input from a user, a selection of one of the multiple responses and directing the selected one of the multiple responses to the autonomous tractor system.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 is a block diagram of an example environment that may include an operator directed autonomous system;

FIG. 2 illustrates an example user interface;

FIG. 3 illustrates a flowchart of an example method of an operator directed autonomous system;

FIG. 4 illustrates a flowchart of another example method of an operator directed autonomous system;

FIG. 5 illustrates a flowchart of another example method; and

FIG. 6 illustrates a block diagram of an example computing system, all arranged in accordance with at least one embodiment of the present disclosure.

### DESCRIPTION OF EMBODIMENTS

Agricultural undertakings, including farming, are often time consuming and of a large scale such that power vehicles and/or equipment provide a great benefit in accomplishing tasks related thereto. Tractors and other agricultural equipment may be used to help reduce the amount of time required to cultivate land and/or crops. In some circumstances, the tractors and/or other equipment may be configured to operate autonomously, such that tasks may be completed without an operator being immediately present.

In some circumstances, it may be desirable to preplan the navigation and/or tasks to be performed by an autonomous tractor, such that the scope of the operations to be performed may be limited. For example, an autonomous tractor may be configurable to perform multiple tasks over an environment and it may be desirable to limit the number of tasks to be performed and/or the size of the operational environment. In some circumstances, in the course of the autonomous tractor executing operational instructions (e.g., navigation through the operational environment and/or performing tasks within the operational environment), an unexpected event and/or obstacle may be encountered by the autonomous tractor. It may be desirable for the autonomous tractor to handle some events without further input and/or request direction or confirmation of event handling.

Aspects of the present disclosure address these and other shortcomings of prior approaches by providing a graphical user interface that may display an operational environment associated with an autonomous tractor. An operator may generate operational instructions for the autonomous tractor, which may include navigational waypoints and/or tasks to be performed at, near, or in between the navigational waypoints. In some embodiments, an unexpected event may be detected by the autonomous tractor and the autonomous tractor may attempt to continue performing the operational instructions. Alternatively, the autonomous tractor may determine and/or provide one or more proposed responses to the unexpected event to an operator, such that the operator may select a response from the proposed responses directing the autonomous tractor in handling the event. The operator response directing the autonomous tractor in handling the unexpected event may include updating the operational instructions of the autonomous tractor.

In the present disclosure, the term “tractor” may refer to an agricultural tractor and/or other power equipment or vehicles that may be used in an agricultural setting. Alternatively, or additionally, the term “tractor” may include any power vehicle that may be configured to operate autonomously, which may further be used in the agricultural setting or any other applicable setting. Further, while discussed in primarily an agricultural setting, some embodiments of the present disclosure may be used in other settings, such as mining, construction, and/or other locales where large machinery, such as a tractor, may be beneficial.

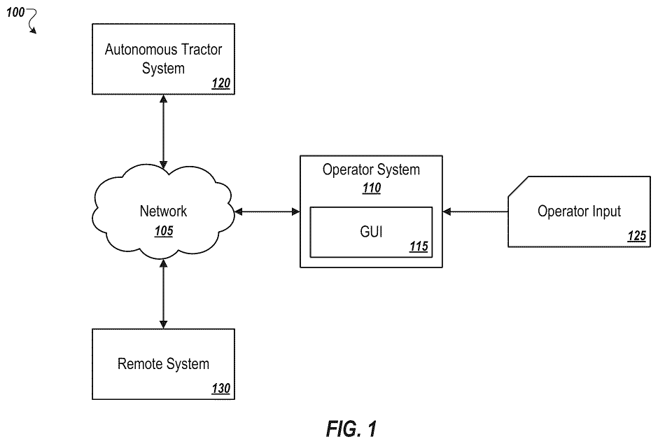

FIG. 1 is a block diagram of an example environment 100 that may include an operator directed autonomous system, in accordance with at least one embodiment described in the present disclosure. The environment 100 may include a network 105, an operator system 110, an autonomous tractor system 120, and a remote system 130. The operator system 110 may include a graphical user interface (GUI) 115.

The network 105 may be configured to communicatively couple the operator system 110, the autonomous tractor system 120, and the remote system 130. In some embodiments, the network 105 may be any network or configuration of networks configured to send and receive communications between systems. In some embodiments, the network 105 may include a wired network, an optical network, and/or a wireless network, and may include numerous different configurations, including multiple different types of networks, network connections, and protocols to communicatively couple systems in the environment 100.

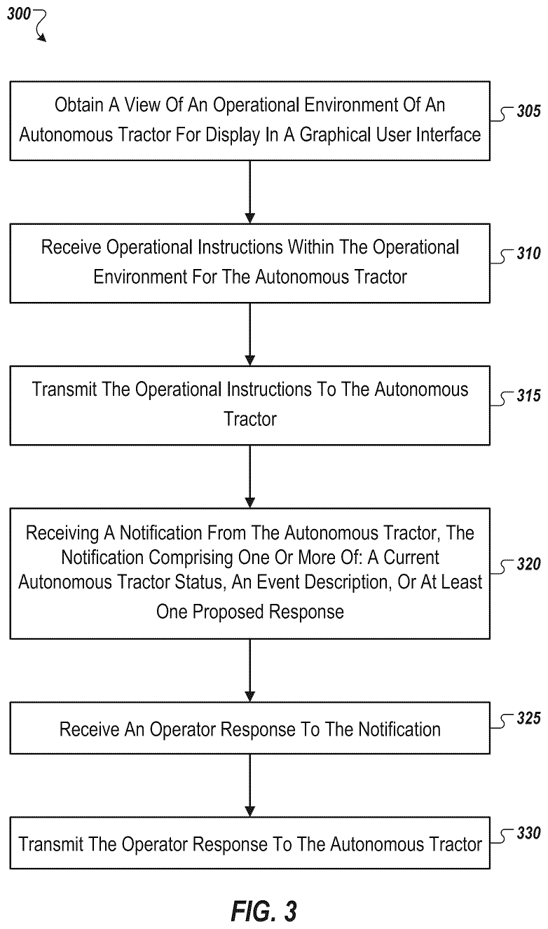

Each of the operator system 110, the autonomous tractor system 120, and the remote system 130 may include any electronic or digital computing system. For example, each of the operator system 110, the autonomous tractor system 120, and the remote system 130 may include a desktop computer, a laptop computer, a smartphone, a mobile phone, a tablet computer, server, a processing system, or any other computing system or set of computing systems that may be used for performing the operations described in this disclosure and for communicating data between the operator system 110, the autonomous tractor system 120, and the remote system 130. An example of such a computing system is described below with reference to FIG. 3. In some embodiments, each of the operator system 110, the autonomous tractor system 120, and/or the remote system 130 may include a data storage or a data buffer (not illustrated) which may be configured to store at least a portion of generated data, instructions, routines, environments, and the like, as further described herein.

In some embodiments, the operator system 110 may display the GUI 115. The GUI 115 may be configured to provide an interface for an operator to interact with the operator system 110. In some embodiments, the GUI 115 may display information and/or data associated with the autonomous tractor system 120. For example, the GUI 115 may display one or more of a current task being performed, a current navigation waypoint, a current runtime, an estimated time to completion of the current task, an estimated time to completion of the operational instructions, various statuses of the autonomous tractor system 120 which may include, but not be limited to, fuel level, such as a battery level or oil based fuel, engine temperature, oil pressure, and/or other information associated with the autonomous tractor system 120, and the like.

Alternatively, or additionally, the GUI 115 may display an operational environment associated with the autonomous tractor, such as a physical area in which the autonomous tractor may be configured to operate. For example, the GUI 115 may provide an overhead view (or any other view as described herein) of the operational environment in which the autonomous tractor system 120 may be configured to operate. Alternatively, or additionally, the GUI 115 may display one or more communications that may be received from the autonomous tractor system 120 and/or the remote system 130. For example, a notification received from the autonomous tractor system 120 may include a description of an unexpected event and/or one or more proposed responses directed to handling the event.

In some embodiments, the operator system 110 may obtain operator input 125. The operator input 125 may include one or more actions associated with one or more of the displayed information, the operational environment, and/or the received communications. For example, the operator input 125 may include adding one or more autonomous navigation waypoints and/or one or more autonomous tasks to the operational environment via the GUI 115 of the operator system 110. In another example, in response to a notification being received from the autonomous tractor system 120 and displayed on the GUI 115, the operator input 125 may include an operator response to the notification, such as a selection of a proposed response and/or an update of the operational instructions. In these or other embodiments, the operator input 125 may be obtained through any input method for interacting with a computing system, such as a keyboard and/or mouse, a stylus, operator touch on a display, voice commands, and/or similar input methods.

In some embodiments, the operator system 110 may obtain an operational environment, which may include a view thereof, that may be associated with the autonomous tractor system 120. The operational environment may include an area in which the autonomous tractor system 120 may be configured to perform one or more operations. The area in which the operations may be performed may be designated by a boundary in the operational environment. For example, the operational environment may include a tract of land which may have crops disposed thereon, in which the autonomous tractor system 120 may perform operations in furtherance of improving the tract of land and/or the crops located thereon. In some embodiments, the operational environment be configured to be displayed by the GUI 115.

In some embodiments, the operational environment may be displayed as a view to the operator, such as an overhead view. For example, the operational environment may be displayed as a top-down image obtained from a location above the operational environment. Alternatively, or additionally, the operational environment may be displayed in other views which may include, but not be limited to, a perspective view, an isometric view, a three-dimensional view, and/or other views. In some embodiments, an operator may be configured to change the view of the operational environment from a first view to a second view. For example, an operator may initially view the operational environment as a top-down image and the operator may change the view of the operational environment to an isometric view of the operational environment. In these or other embodiments, the view of the operational environment may be obtained from a camera image, a satellite image, a radar scan, a LIDAR scan, and/or any other similar image gathering system and/or method. For example, in some embodiments, one or more of the views may be obtained from one or more sensors of the autonomous tractor system 120. For example, a camera and/or a lidar sensor may obtain a view of the operational environment. Alternately or additionally, one or more of the views may be obtained from a data storage connected to the network 105. For example, the data storage may be associated with the remote system 130. In these and other embodiments, the one or more views may be overhead images of the operational environment captured by a satellite or drone. Alternately or additionally, the overhead images may be stored by a data storage of the operator system 110 and/or the autonomous tractor system 120.

In some embodiments, the view of the operational environment may include one or more overlays or displays that may be associated with the area in which the autonomous tractor system 120 is configured to operate. For example, when the view of the operational environment is a previous image or a map type image, the overlays or displays may include real time or near to real time audio, digital images (e.g., captured by the autonomous tractor system 120, satellites and/or drones), infrared images (e.g., captured by the autonomous tractor system 120, satellites, and/or drones). As another example, the overlay or display may include information obtained by the autonomous tractor system 120 or from other information databases, such as terrain conditions, soil conditions, weather conditions, flood conditions, time of day, visibility deterrents (e.g., smoke, haze, fog, and/or other factors that may affect visibility), fire, and other environmental conditions, among other information. For example, the information may be obtained from government agencies or other entities regarding the operational environment. The general, the overlays may provide further information for the operator regarding the operational environment. In some embodiments, the overlays may be configured to be selected or deselected by an operator for display on the GUI 115.

In some embodiments, the operator system 110 may obtain autonomous operational instructions to be transmitted to the autonomous tractor system 120. In some embodiments, the operational instructions may be provided to the operator system 110 via the operator input 125, such as by way of the GUI 115. The operational instructions may include navigation instructions such as one or more waypoints or routes which may direct movement through the operational environment, one or more tasks to be performed within the operational environment, instructions indicating when to request remote operation, and the like. In these or other embodiments, the operator system 110 may be configured to transmit the operational instructions to another system or device, such as the autonomous tractor system 120 and/or the remote system 130, via the network 105.

In some embodiments, the operator input 125 may include interacting with the GUI 115 to generate and/or confirm the operational instructions for the autonomous tractor system 120. In some embodiments, the operator input 125 may include dragging and dropping one or more waypoints for the autonomous tractor system 120 to navigate through the operational environment. For example, the operator input 125 may drag and drop a first waypoint, a second waypoint, and a third waypoint, all within the boundaries of the operational environment. The waypoints may direct the autonomous tractor system 120 to navigate autonomously through the operational environment by way of the first waypoint, the second waypoint, and the third waypoint. The operator input 125 may include dragging and dropping any number of waypoints, such as one, two, five, ten, twenty, fifty, or any other number of waypoints.

In some embodiments, the number of waypoints obtained by the operator system 110 may be associated with a task the operator input 125 is directing the autonomous tractor system 120 to perform. For example, in instances in which the operator input 125 is directing the autonomous tractor system 120 to mow in an area, the operator input 125 may include one waypoint which may direct the autonomous tractor system 120 to autonomously move to the area and to autonomously mow the area. In another example, in instances in which the operator input 125 is directing the autonomous tractor system 120 to spray a pesticide, the operator input 125 may include many waypoints, which may direct the autonomous tractor system 120 on a route through crops, plants, trees, and/or other known obstacles in the operational environment that the autonomous tractor system 120 may autonomously follow and autonomously spray the pesticide. In these and other embodiments, the operator input 125 may include an indication of first areas along the path created by the waypoints that may be sprayed and second areas that may not be sprayed with the pesticide.

In some embodiments, the operator input 125 may include selecting operational instructions for the autonomous tractor system 120 to perform, such as from a collection of operations. For example, a drop-down menu may be displayed, such as via the GUI 115, which may include multiple operations that may include different waypoints and/or tasks. The operator input 125 may select one or more operations from the drop-down menu for the autonomous tractor system 120 to perform.

In some embodiments, the collection of operations may include one or more generated recommendations. In some embodiments, the generated recommendations may be generated by the operator system 110 based on the operator input 125 associated with previous operational instructions. For example, previous operational instructions may have included performing a first task following a set of waypoints on a first day of a first week, such that on the first day of a second week, the generated recommendations by the operator system 110 may include the previous operational instructions as an option.

Alternatively, or additionally, the generated recommendations may be generated by another system, such as the autonomous tractor system 120 and/or the remote system 130. For example, either of the autonomous tractor system 120 or the remote system 130 may obtain data associated with the operational environment, such as during a performance of a task by the autonomous tractor system 120 and may perform an analysis on the obtained data. Based on an analysis of the obtained data, the autonomous tractor system 120 and/or the remote system 130 may generate one or more recommendations for future operational instructions that may be included in the collection of operations displayed by the GUI 115. In these or other embodiments, the generated recommendations may be generated in view of one or more factors, such as time of day, time of year, day of the week, week of the month, month of the year, current weather conditions, preceding weather conditions, predicted weather conditions, crops associated with an operational environments, harvesting information regarding the crops, tasks included in the operational instructions, recently completed operational instructions, and/or other factors related to the autonomous tractor system 120, the operational environment, and/or associated factors.

In some embodiments, the operator input 125 may include a request for remote access in conjunction with or in the alternative to dragging and dropping waypoints and/or operations directed by previous operational data. For example, the operator input 125 may add a first waypoint and a first task to be performed by the autonomous tractor system 120 in the operational environment, and a second waypoint where upon reaching the second waypoint, the autonomous tractor system 120 may transmit a request to the operator system 110 and/or the remote system 130. The request may indicate a request for additional waypoints and/or tasks. Alternately or additionally, the request may include having the autonomous tractor system 120 wait at the second waypoint to be remotely controlled via the remote system 130 and/or the operator system 110.

In these or other embodiments, the operational instructions provided by the operator input 125 into the operator system 110 may include enumerated instructions, which may include a set of step-by-step instructions of navigation waypoint and/or tasks to perform at the waypoints. For example, the operational instructions may include performing a first task at a first waypoint, performing the first tasks at a second waypoint, performing a second task at a third waypoint, and so forth. The operator input 125 may indicate each navigation waypoint and/or task to be performed as part of the operational instructions.

Alternatively, or additionally, the operational instructions selected by the operator input 125 into the operator system 110 may include selecting one or more predefined operational instructions to be performed by the autonomous tractor system 120. The predefined operational instructions may include one or more navigation waypoints and/or one or more tasks to be performed by the autonomous tractor system 120. In some embodiments, the predefined operational instructions may be obtained from previously determined operational instructions, such as operational instructions from the operator input 125, as described herein.

Alternatively, or additionally, the predefined operational instructions may be based on the performance of previous operational instructions performed by the autonomous tractor system 120. For example, the operator input 125 into the operator system 110 including the enumerated instructions for the autonomous tractor system 120 may be saved into a collection of operational instructions. In instances in which future operational instructions may include repeating the enumerated instructions, the future operational instructions may include selecting desired enumerated instructions from the collection of operational instructions. In another example, and as described herein, the predefined operational instructions may be generated by another system, such as the autonomous tractor system 120 and/or the remote system 130.

In some embodiments, the operator system 110 may categorize the operational instructions into three main mission types. For example, the three mission types may include an open field mission, an in-row mission, and a transport mission. Within the three main mission types, submission may be used as well. For example, the submissions may include recharge a battery, swapping a battery pack, and changing an implement, among others. In these and other embodiments, the three main mission types may be implemented as soon as the command is received. Alternately or additionally, the three main mission types may be implemented after some time or some event occurs. For example, a mission may be implemented in response to an amount of time passing that satisfies a threshold or after some event. For example, a mission may be implemented after rain or watering of a certain area is completed. As another example, a mission may be implemented in response to movement of animals or some other environmental aspects related to the operational environment.

In some embodiments, the open field mission may include the autonomous tractor system 120 performing an operation in a particular area of the operational environment. In these and other embodiments, the operator system 110 may obtain the particular area of the operational environment based on the operator input 125 through the graphical user interface GUI 115. Alternately or additionally, the operator system 110 may obtain the particular area from other information, such as historical information or from another source. In these and other embodiments, the particular area may be obtained by a user outlining the particular area in the operational environment via the GUI 115. The outline may be a rough outline such as through tracing a finger along a map displayed on the graphical user interface GUI 115. In these and other embodiments, the operator system 110 may match the outline with particular elements in the map, such fences, roads, different crops, or delineations of change in the area of the map to determine the particular area.

In these and other embodiments, the operator system 110 may detect an implement attached to the autonomous tractor system 120 and perform the operations associated with the implement in the particular area. Alternately or additionally, the implement may be assigned and the autonomous tractor system 120 may fetch and couple the implement to the autonomous tractor system 120 based on the mission. For example, in response to a mission to mow a field, the autonomous tractor system 120 may seek a mowing implement, attach the mowing implement, and proceed to mowing in the particular area using the mowing implement. In these and other embodiments, the autonomous tractor system 120 may select a navigational path to perform the operation in the particular area. The navigational path to perform the operation may be selected according to any constraints associated with the particular area, the operation, and/or as provided in the operator input 125.

In some embodiments, an in-row mission may be associated with the autonomous tractor system 120 performing operations in an area of the operational environment that includes rows of crops. In these and other embodiments, the operator system 110 may obtain operator input 125 to provides navigation waypoints for the autonomous tractor system 120 to navigate through the rows to perform a particular operation. In these and other embodiments, the operator system 110 may provide historical navigation waypoints for selection by the user. Alternately or additionally, the operator system 110 may provide suggested navigation waypoints based on previously performed operations. For example, the autonomous tractor system 120 may have performed operations on a first set of the rows recently and the operator system 110 may suggest navigation on a second set of rows that had not had the operation performed as recently. In these and other embodiments, the operator input 125 may include drawing a path along rows represented on a map presented on the graphical user interface GUI 115.

In some embodiments, the transport mission may be associated with transporting crops during harvesting of the crops. The crops may be harvested at a first location in the operational environment. Larger equipment, such as larger trucks configured to haul the harvested crops due to the operational environment may not be able to access the first location and may be located at a second location. In these and other embodiments, the autonomous tractor system 120 may be configured to haul the harvested crops from the first location to the second location and then return to the first location after the harvested crops are unloaded for further harvested crops. In these and other embodiments, the first and second locations may be selected based on the operator input 125 obtained by the operator system 110.

In some embodiments, the first location may change as the harvest progresses. For example, the harvest may start at a first row and may progress along the rows. If the first location is selected at the first row, the operator system 110 may return not return to the first row but may return to a location from which the autonomous tractor system 120 left after being filled with the harvested crop. For example, the autonomous tractor system 120 may have started at the first row and been filled at the fifth row. In these and other embodiments, the autonomous tractor system 120 may return to the fifth row after traveling to the second location. Alternately or additionally, the autonomous tractor system 120 may return to the fifth row and further based on sensor input adjust for harvesting that was completed during hauling the harvested crop to the second location.

In some embodiments, the operator system 110 may obtain operator input 125 for selecting a path to the second location, such as via navigational waypoints. Alternately or additionally, the operator system 110 may determine the path to the second location based on the topography of the operational environment and/or the crop being harvested. Alternately or additionally, the operator system 110 may determine a path to the second location based on selecting paths that are made from a particular material, have a particular form, or that do not include a particular material and/or form. For example, the operator system 110 may select a path that may follow dirt, gravel, or paved paths to the second location. Alternately or additionally, the operator system 110 may select a path that may not pass over areas with vegetation or have a particular slope or grade. In these and other embodiments, the criteria for traveling from the harvesting location to the second location may be different than the criteria for traveling from the second location to the harvesting location due to the autonomous tractor system 120 carrying the harvested crop.

Alternatively, or additionally, the operational instructions selected by the operator input 125 into the operator system 110 may include general instructions (e.g., non-enumerated operational instructions) to the autonomous tractor system 120. The general instructions may include a broad area and/or task to be performed. In response to the general instructions, the autonomous tractor system 120 may be configured to perform runtime decisions associated with the area and/or task. For example, in instances in which the general instructions from the operator input 125 for the autonomous tractor system 120 may include only a mowing task, the autonomous tractor system 120 may begin mowing all areas within the operational environment in which vegetation to be mowed is detected.

In some embodiments, the autonomous tractor system 120 may be configured to receive, process, and/or implement received instructions associated with an autonomous tractor. For example, the autonomous tractor system 120 may receive operational instructions from the operator system 110, as described herein. In some embodiments, the autonomous tractor system 120 may include an autonomous tractor having mechanical elements, one or more sensors, and/or at least one computer processing module.

Generally, at least a portion of the autonomous tractor system 120, such as an associated computer processing module, may include code and routines configured to enable a computing system to perform one or more operations. Alternatively, or additionally, at least a portion of the autonomous tractor system 120 may be implemented using hardware including a processor, a microprocessor (e.g., to perform or control performance of one or more operations), a field-programmable gate array (FPGA), an application-specific integrated circuit (ASIC), and/or other hardware. In some other instances, the autonomous tractor system 120 may be implemented using a combination of hardware and software. In the present disclosure, operations described as being performed by the autonomous tractor system 120 may include operations that the autonomous tractor system 120 may direct a corresponding system to perform.

In these or other embodiments, the computer processing module of the autonomous tractor system 120 may be communicatively coupled with the sensors and/or the associated mechanical elements of the autonomous tractor system 120. As such, the computer processing module may be configured to direct the operation of the mechanical elements of the autonomous tractor system 120 in view of received operational instructions and/or data from the sensors. In some embodiments, the operation of the autonomous tractor system 120 may be in response to operational instructions received from another system, such as the operator system 110, as described herein. For example, operational instructions to the autonomous tractor system 120 may include one or more tasks to be performed at one or more waypoints within an operational environment.

In some embodiments, in response to receiving operational instructions, the autonomous tractor system 120 may begin to perform the operational instructions. In some embodiments, the operational instructions may include one or more windows of time in which the operational instructions may be performed. For example, it may be desirable for the autonomous tractor system 120 to perform one or more tasks in the morning and/or in the evening and the operational instructions may include a morning start time and/or an evening start time.

In these or other embodiments, while performing the operational instructions, the autonomous tractor system 120 may experience an unexpected event. The unexpected event may include the occurrence of unexpected conditions, such as weather conditions, mechanical conditions and/or encountering an unexpected object, obstacle, or condition, such an environmental condition, e.g., mud, standing water, etc., along the route the autonomous tractor system 120 is following while performing a mission. In some embodiments, the autonomous tractor system 120 may be configured to perform one or more responsive actions to the event. For example, the autonomous tractor system 120 may generate a log of the event and an associated autonomous tractor system status, determine an event description, an event severity, and/or determine one or more proposed responses to the event.

In some embodiments, the autonomous tractor system status may include current task run time, total tractor run time, percent of task completed, battery and/or fuel level, estimated time to completion, and/or other statuses associated with the autonomous tractor system 120. In some embodiments, the proposed responses that may be determined by the autonomous tractor system 120 may include continuing to perform the task, avoid the event and perform the task, navigate to a different area within the operational environment and continue performing the task and/or a different task, wait to receive new operational instructions, and the like. In some embodiments, the event description may include a semantic description of the detected event, a generic description of the event (e.g., obstacle in the path), a selected event from a predefined collection of events, and/or other descriptions associated with the event. Further, the event description may also include an event severity rating associated with the event. For example, the severity rating may include a number from a scale, a color associated with the severity rating, a visual indicator, and/or other indicators to describe the severity of the event. For example, a first event may include a severity rating of three (e.g., on a scale of one to three) and/or a color of red (e.g., on a scale of green, yellow, red), which may indicate the first event is categorized as severe, and a second event may include a severity rating of one and/or green, which may indicate the second event is categorized as minor.

In response to the event, the autonomous tractor system 120 may transition into an idle state. Alternatively, or additionally, the autonomous tractor system 120 may be configured to generate and/or transmit a notification to another system, such as the operator system 110 and/or the remote system 130. In some embodiments, the notification may include one or more of the responsive actions generated by the autonomous tractor system 120. For example, the notification may include the event description, the current autonomous tractor system status, and/or at least one proposed response. In these or other embodiments, the notification may include a request for operator input directed to handling the detected event.

In some embodiments, the autonomous tractor system 120 may remain in the idle state until an operator response is received from another system, such as the operator system 110 and/or the remote system 130. Alternatively, or additionally, in instances in which the autonomous tractor system 120 is in an idle state and fails to receive an operator response within a threshold amount of time, the autonomous tractor system 120 may perform event handling in view of the event. For example, in instances in which no operator response is received, the autonomous tractor system 120 may attempt to continue a current task at a different waypoint, perform a new task, return to a charging station, and/or other event handling responses. The threshold amount of time may include a particular amount of time (e.g., one minute, five minutes, ten minutes, one hour, etc.), may be input into the operator system 110, such as by the operator input 125, may include a variable amount of time based on conditions of the autonomous tractor system 120, an amount of and/or environmental conditions, such as a time of the day, weather conditions, among other environmental conditions, and may include any length of time.

Alternatively, or additionally, the autonomous tractor system 120 may include one or more predetermined routines directed to responding to an event. For example, in response to an event in which no operator response is provided, the autonomous tractor system 120 may power down in a current location, may return to a known location such as an associated charging station, and/or may attempt to proceed in view of the event.

In these or other embodiments, the operational instructions provided by the operator system 110 may include one or more prioritized event handling instructions. For example, the operator system 110 may include a first event handling instruction to proceed in view of the event based on a severity of the event and a second event handling instruction to return to a charging station, where in instances in which the first event handling instruction is not performed, the second event handling instruction may be performed.

In some embodiments, the operator system 110 may present a set of event handling instructions to propose to an operator based on any event that occurs. For example, the operator system 110 may present the set of event handling instructions to the operator that is remote from the autonomous tractor system 120 via the remote system 130 in response to the event. In these and other embodiments, the operator system 110 may also presenting imaging of the event. For example, the autonomous tractor system 120 may encounter an animal. The autonomous tractor system 120 may stop and provide an alert. The remote system 130 may display the animal and provide the set event handling instructions for selection of one of the set of event handling instructions by the operator.

The operator system 110 may be configured to select one of the event handling instructions from among the set of event handling instructions displayed. After selection, the autonomous tractor system 120 may perform the selected event handling instructions. After selection, the autonomous tractor system 120 may perform the event handling instruction and the other instructions previously provided if applicable in view of the selected event handling instruction. The set of event handling instructions may include and number of event handling instructions, including 2, 3, 5, 6, 8, 10, 12 or more. For example, the set of event handling instructions may be selected from a group of instructions that include skip current operation and do not return, skip current operation and return later, cancel current mission, honk horn, speaking through an intercom, move to another mission, proceed slowly and move around an obstacle, wait for help to arrive, wait until the event is terminated, among others.

In these and other embodiments, an operation may include a row in which an action is being perform and a mission may include an action to be performed over a particular area of the operational environment. As an example, a mission may be to cut grass among rows of a trees. In response to an animal being a row, the set of event handling instructions may be provided to an operator. In response to the event handling instruction being to cancel the current mission, no further cutting may occur and the autonomous tractor system 120 may proceed to another mission or return to a secure location. As another example, in response to the event handling instruction being to skip the current operation and return later, the autonomous tractor system 120 may proceed to another row to cut the grass and return to the row after cutting the grass in one or more other rows. As another example, in response to the event handling instruction being to honk the horn, the autonomous tractor system 120 may proceed to honk the horn and wait for the animal to move. In response to the animal moving, the autonomous tractor system 120 may proceed to cut the grass in the row. In response to the animal not moving, the autonomous tractor system 120 may request another event handling instruction from the operator.

In some embodiments, the operator system 110 may record an event handling instruction from the operator. In these and other embodiments, the operator system 110 may further record the consequences of the event handling instruction. For example, for the event handling instruction of skip a row and do not return, data about the row that is skipped may recorded. For example, the data may include a location of the row, a time when the decision was made, an image of the row that results in the event, and/or other data about the row and/or associated with the event handling instruction. In these and other embodiments, the operator system 110 may be configured to provide information to an operator after receiving the event handling instruction. The information may include the data associated with the event handling instruction. For example, the information may indicate a location of where originally scheduled work was not completed, and an image of the location so further instructions may be received regarding the location of the event. In these and other embodiments, the operator system 110 may provide a reminder to the operator that the event handling incident occurred to allow for work at the location of the event to be further handling at a later time in response to all work at the location of the event not being completed.

In some embodiments, the autonomous tractor system 120 may be configured to transmit operational data to another system such as the operator system 110 and/or the remote system 130. In some embodiments, the autonomous tractor system 120 may transmit the operational data periodically. For example, the autonomous tractor system 120 may be configured to transmit operational data every second, twenty seconds, forty-five seconds, one minute, five minutes, one hour, and/or other increments of time. Alternatively, or additionally, the autonomous tractor system 120 may continuously or near continuously transmit the operational data.

In some embodiments, the transmitted operational data may be analyzed by the operator system 110 and/or the remote system 130 to determine one or more parameters associated with the autonomous tractor system 120 and/or the associated operations thereof. For example, an analysis of the transmitted operational data may indicate a decrease in efficiency of at least a portion of the autonomous tractor system 120, which may be used to determine a maintenance routine for the autonomous tractor system 120.

In some embodiments, in response to receiving the notification from the autonomous tractor system 120, an operator of the operator system 110 and/or an operator of the remote system 130 may provide an operator response to the notification. In some embodiments, the operator response may include selecting from the one or more proposed responses generated by the autonomous tractor system 120. For example, in response to the autonomous tractor system 120 generating a number of proposed responses, the operator response, such as from the operator system 110, may include selecting a first response from the number of proposed responses. Alternatively, or additionally, an operator of the operator system 110 and/or the remote system 130 may provide an operator response not associated with the proposed responses from the autonomous tractor system 120. For example, the operator response in response to an event may include new operational instructions for the autonomous tractor system 120 that may differ from the generated proposed responses.

In some embodiments, the remote system 130 may be configured to receive data from the autonomous tractor system 120, such as a notification of an event and/or proposed responses, and an operator of the remote system 130 may be configured to provide an operator response to the notification from the autonomous tractor system 120. Alternatively, or additionally, the remote system 130 may include a data center which may be monitored by one or more persons such that in the event a notification is received from the autonomous tractor system 120, an operator response may be provided to the autonomous tractor system 120 by the remote system 130.

In these or other embodiments, either of the operator system 110 and the remote system 130 may be configured to provide operator responses to the notifications from the autonomous tractor system 120. In some embodiments, the notifications may first be provided to the operator system 110 and secondly to the remote system 130, such as in instances in which the operator system 110 fails to provide a response. For example, in response to a notification being transmitted to the operator system 110 and an amount of time elapsing that is greater than a threshold, the notification may be transmitted to the remote system 130 to obtain an operator response. The amount of time that may elapse before the remote system 130 provides a response may vary based on the environment conditions, the notification, the time of day, a day of the week, and/or based on some schedule determined based historical data or from input from an operator or some other individual.

Alternatively, or additionally, both the operator system 110 and the remote system 130 may jointly receive a notification from the autonomous tractor system 120 and either of the operator system 110 or the remote system 130 may provide an operator response to the notification. Alternatively, or additionally, the operator system 110 may arrange one or more rules that may direct a notification from the autonomous tractor system 120 to either of the operator system 110 or the remote system 130. For example, a first notification associated with a first event having a low (e.g., minor) severity rating may be directed to the remote system 130 and a second notification associated with a second event having a high (e.g., severe) severity rating may be directed to the operator system 110. In another example, in instances in which a notification transmitted to the operator system 110 is not responded to within a threshold amount of time, the notification may be transmitted to the remote system 130.

In a working example, the GUI 115 of the operator system 110 may display an operational environment. An operator may provide operator input 125 to the operator system 110 including operational instructions to the autonomous tractor system 120. The operational instructions may include navigation waypoints and/or tasks for the autonomous tractor system 120 within the operational environment. For example, the operational instructions may include a task of mowing an area and navigation waypoints that may direct the autonomous tractor system 120 through the area. The operational instructions may be transmitted from the operator system 110 to the autonomous tractor system 120. While performing the operational instructions, the autonomous tractor system 120 may encounter an unexpected event. Continuing the example, during performance of the mowing operation, the autonomous tractor system 120 may detect a fallen tree branch in the operational environment. In response to the event, the autonomous tractor system 120 may perform a first course of action. For example, the autonomous tractor system 120 may enter an idle mode, a shutdown mode, or return to a predetermined location, such as a charging station. Additionally, the autonomous tractor system 120 may generate one or more of a current autonomous tractor system status, a description of the event, a severity associated with the event, and/or at least one proposed response as a notification. Continuing the example, the autonomous tractor system 120 may provide proposed responses that include navigate over the fallen branch with mowing blades engaged, navigate over the fallen branch with mowing blades disengaged, navigate around the area that includes the fallen branch, and/or return to the charging station. The autonomous tractor system 120 may transmit the notification to the operator system 110 and/or the remote system 130 and wait for an operator response. An operator response may be determined by either of the operator system 110 or the remote system 130, such as from the operator input 125, and the operator response may be transmitted to the autonomous tractor system 120. In response to receiving the operator response, the autonomous tractor system 120 may update the operational instructions in view of the operator response and continue executing the operational instructions.

Modifications, additions, or omissions may be made to the environment 100 without departing from the scope of the present disclosure. For example, the environment 100 may include any number of other components that may not be explicitly illustrated or described. As another example, one or more of the concepts performed by the operator system 110 may be performed by the autonomous tractor system 120. For example, the autonomous tractor system 120 may obtain the operator input 125 regarding initial instructions for performing a task. For example, the initial instructions may include one or more waypoints. After receiving the initial instructions, the autonomous tractor system 120 may begin performance of the initial instructions. During performance of the initial instructions, the autonomous tractor system 120 may send a notification to the operator system 110 regarding an event and one or more proposed responses. In these and other embodiments, the autonomous tractor system 120 may obtain a selected response in response to sending the notification and implement the selected response.

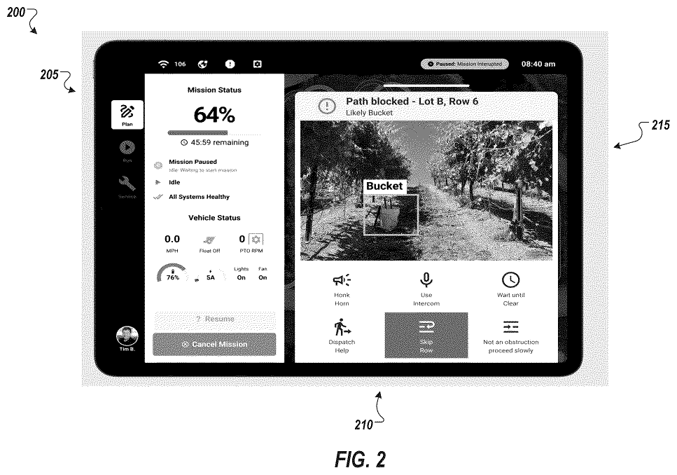

FIG. 2 illustrates an example user interface 200, according to one or more embodiments of the present disclosure. The user interface 200 includes a status section 205, response section 210, and an event section 215. The user interface 200 may be presented by a device. For example, the device may be a smartphone, tablet, computer, or any other type of computing device. The device may be associated with the autonomous tractor system. For example, the device may include a software application that is configured to communicate with the autonomous tractor system. In these and other embodiments, the device may obtain information from the autonomous tractor system and present the information in the user interface 200 as illustrated. event section 215

The status section 205 may include an indication of a status of a current mission being performed by the autonomous tractor system. The mission may have been directed via the device or directly via the autonomous tractor system. For example, the status section 205 may indicate a percent of the mission completed, an amount of time to complete the mission. Alternately or additionally, the status section 205 may indicate a status of the autonomous tractor system. For example, the status section 205 may indicate the mission is paused, any system warning, current status of the autonomous tractor system, e.g., status of lights, fan, battery levels, fuel levels, speed, among other status of the autonomous tractor system.

The response section 210 may indicate multiple different responses that are being suggested by the autonomous tractor system in view of an unexpected event as indicated in event section 215. For example, the response section 210 indicates six responses that may be performed by the autonomous tractor system in response to the event in identified in the event section 215. The responses include honk the horn of the autonomous tractor system, use an intercom on the autonomous tractor system such that the autonomous tractor system may broadcast audio obtained by the device through the user interface 200 and the autonomous tractor system may capture audio at the autonomous tractor system that the device through the user interface 200 may broadcast. The response may also include wait until the event is over or clears, dispatch a human to assist the autonomous tractor system, skip the row, or proceed slowly not an obstruction. The response section 210 may allow a user to select on the response. In response to the selection of a response, the device may provide the response to the autonomous tractor system. The autonomous tractor system may perform the response. Note that in some embodiments, more than one response may be selected for a given event. For example, a first response may be selected. In response to the first response not resulting a particular result, a second response, or subsequent responses may be selected for a given event. For example, if the event was the result of an animal blocking the path of the autonomous tractor system, the response of honking the horn may be used. If the horn does not result in the animal moving, the intercom may be used. If the intercom does not result in the animal moving, either help may be dispatch, another row may be skipped, or the autonomous tractor system may be directed to wait until the row is clear.

In some embodiments, one of the responses may be suggested more than the other responses. For example, the one of the responses may be highlighted as compared to other responses. The one of the responses may be selected to be suggested more based on the one of the responses being historically selected more than other responses for a similar event. Alternately or additionally, the one of the responses may be selected to be suggested more based on an algorithm.

In some embodiments, the response section 210 may include one or more of the same responses, regardless of the event identified in the event section 215. For example, the response section 210 may always include the response of dispatch help. Alternately or additionally, the response section 210 may include responses identified based on the event identified in the event section 215 and/or a mission identified in the status section 205 or a status of the autonomous tractor system in the status section 205. For example, when the event is a bucket, the response section 210 may not include a response of a horn or intercom because the bucket may not be able to respond since the bucket is an inanimate object. In contrast, when the event is caused by a living object, the response section 210 may include the horn or intercom. As another example, in response to the battery level of the autonomous tractor system being below a threshold, the response section 210 may include different responses. For example, in response to the battery level being below a threshold and/or a percentage of the mission being completed, the response section 210 may suggest that the autonomous tractor system skip the row or cancel the mission.

Alternately or additionally, the response section 210 may include responses based on environmental conditions. For example, in response to the event occurring later in the day, the response of wait until clear may not be provided. Alternately or additionally, the response section 210 may include responses based on the mission type. For example, in response to the mission being an in-row mission, the response section 210 may include the response of skip row. In response to the mission being a transport mission, the response may be to determine a new path to return to a particular destination.

In some embodiments, the event section 215 may provide a written description of the unexpected event. The written description may include a location of the event, what likely caused the event, and/or a severity of the event. In these and other embodiments, the event section 215 may further include an image or video feed of the event. For example, as illustrated, the event section 215 includes an image of a bucket that the autonomous tractor system unexpectedly discovered in a row. As illustrated, the event section 215 may further highlight an item that may have resulted in the event. For example, the bucket includes a box around the bucket to highlight the item that resulted in the event. In these and other embodiments, the autonomous tractor system or some other system may perform image recognition applications to identify items in the images.

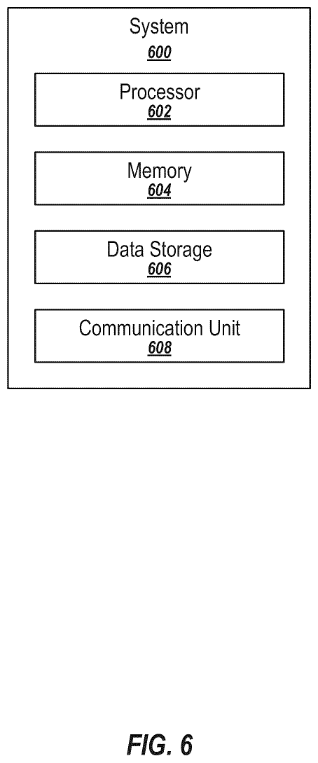

FIG. 3 illustrates a flowchart of an example method 300 of an operator directed autonomous system, according to one or more embodiments of the present disclosure. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, the method 300 is described, by way of example, with respect to the environment of FIG. 1. However, these methods may additionally or alternatively be executed by any one system, or any combination of systems, including, but not limited to, those described herein. In these or other embodiments, one or more operations of the method 300 may be performed by one or more computing devices, such as that described in further detail below with respect to FIG. 6.

The method 300 may begin at block 305 where a view of an operational environment may be obtained. In some embodiments, the view of the operational environment may be associated with an autonomous tractor system and may be displayed in a graphical user interface.

At block 310, operational instructions within the operational environment may be obtained. In some embodiments, the operational instructions may be directed to the operation of the autonomous tractor system within the operational environment. At block 315, the operational instructions may be transmitted to the autonomous tractor system.

At block 320, a notification may be received from the autonomous tractor system. In some embodiments, the notification may include a current autonomous tractor system status. Alternatively, or additionally, the notification may include an event description. Alternatively, or additionally, the notification may include at least one proposed response.

At block 325, an operator response to the notification may be received. In some embodiments, the operator response may be input via the graphical user interface. At block 330, the operator response may be transmitted to the autonomous tractor system. In some embodiments, in response to receiving the operator response, the autonomous tractor system may update the operational instructions.

Modifications, additions, or omissions may be made to the method 300 without departing from the scope of the present disclosure. For example, although illustrated as discrete blocks, various blocks of the method 300 may be divided into additional blocks, combined into fewer blocks, or eliminated, depending on the desired implementation.

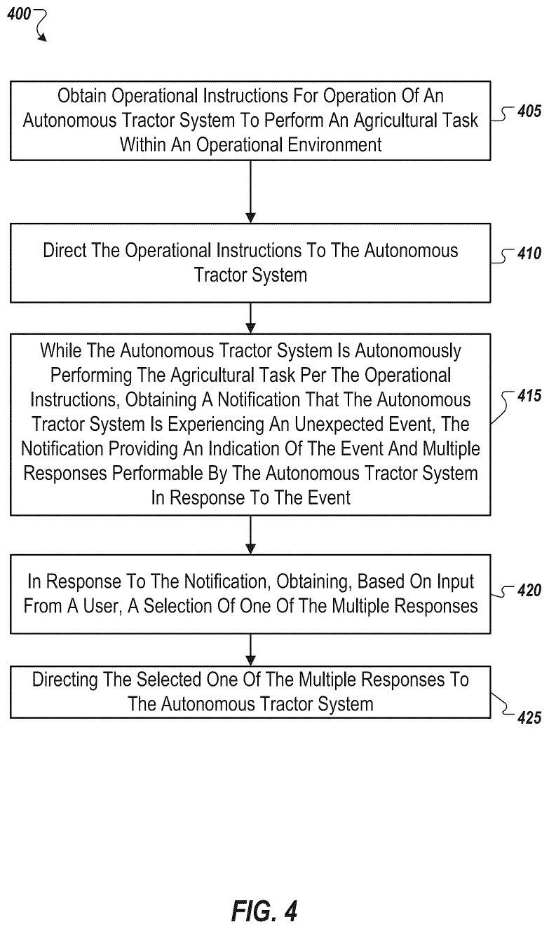

FIG. 4 illustrates a flowchart of another example method 400 of an operator directed autonomous system, according to one or more embodiments of the present disclosure. Each block of method 400, described herein, comprises a computing process that may be performed using any combination of hardware, firmware, and/or software. For instance, various functions may be carried out by a processor executing instructions stored in memory. The method 400 may also be embodied as computer-usable instructions stored on computer storage media. The method 400 may be provided by a standalone application, a service or hosted service (standalone or in combination with another hosted service), or a plug-in to another product, to name a few. In addition, the method 400 is described, by way of example, with respect to the environment of FIG. 1. However, these methods may additionally or alternatively be executed by any one system, or any combination of systems, including, but not limited to, those described herein. In these or other embodiments, one or more operations of the method 400 may be performed by one or more computing devices, such as that described in further detail below with respect to FIG. 6.

The method 400 may begin at block 405 where operational instructions may be obtained for operation of an autonomous tractor system to perform an agricultural task within an operational environment. At block 410, the operational instructions may be directed to the autonomous tractor system.

At block 415, while the autonomous tractor system is autonomously performing the agricultural task per the operational instructions, a notification that the autonomous tractor system is experiencing an unexpected event may be obtained. In some embodiments, the notification may provide an indication of the event and multiple responses performable by the autonomous tractor system in response to the event. In some embodiments, one or more of the multiple responses provided in the notification may be selected based on the unexpected event experienced by the autonomous tractor system. In these and other embodiments, one or more of the multiple responses provided in the notification may be the same regardless of the unexpected event experienced by the autonomous tractor system. Alternately or additionally, one or more of the multiple responses provided in the notification may be selected based on the agricultural task being performed by the autonomous tractor system. In some embodiments, the notification may be obtained in real-time while the autonomous tractor system is performing the agricultural task. Alternately or additionally, the notification may include an image captured by autonomous tractor system that relates to the unexpected event.

At block 420, in response to the notification, a selection of one of the multiple responses may be obtained based on input from a user In some embodiments, the user may be separate from the autonomous tractor system such that the user cannot see or interact directly with the autonomous tractor system.

At block 425, the selected one of the multiple responses may be directed to the autonomous tractor system.

Modifications, additions, or omissions may be made to the method 400 without departing from the scope of the present disclosure. For example, although illustrated as discrete blocks, various blocks of the method 400 may be divided into additional blocks, combined into fewer blocks, or eliminated, depending on the desired implementation.

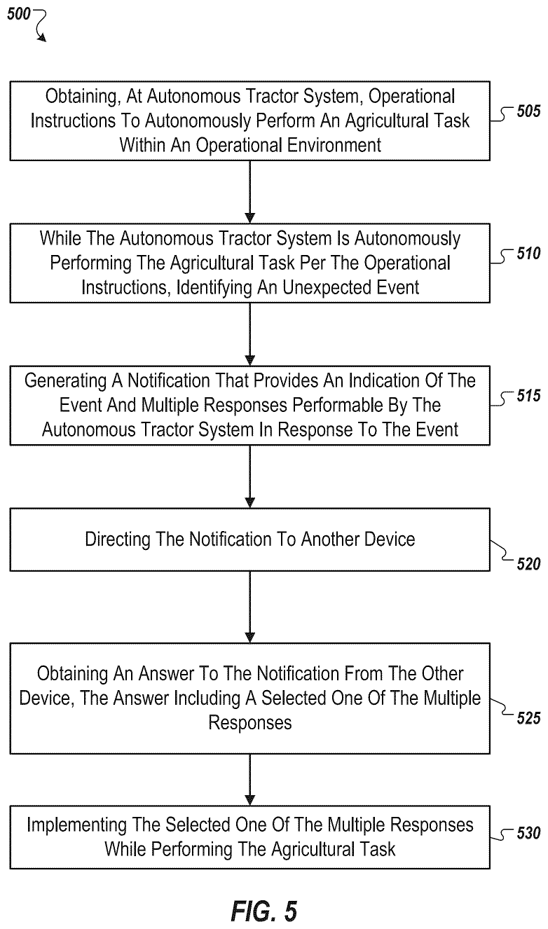

FIG. 5 illustrates a flowchart of another example method 500, according to one or more embodiments of the present disclosure. Each block of method 500, described herein, comprises a computing process that may be performed using any combination of hardware, firmware, and/or software. For instance, various functions may be carried out by a processor executing instructions stored in memory. The method 500 may also be embodied as computer-usable instructions stored on computer storage media. The method 500 may be provided by a standalone application, a service or hosted service (standalone or in combination with another hosted service), or a plug-in to another product, to name a few. In addition, the method 500 is described, by way of example, with respect to the environment of FIG. 1. However, these methods may additionally or alternatively be executed by any one system, or any combination of systems, including, but not limited to, those described herein. In these or other embodiments, one or more operations of the method 500 may be performed by one or more computing devices, such as that described in further detail below with respect to FIG. 6.

The method 500 may begin at block 505 where operational instructions to autonomously perform an agricultural task within an operational environment may be obtained at autonomous tractor system.

At block 510, while the autonomous tractor system is autonomously performing the agricultural task per the operational instructions, an unexpected event may be identified.

At block 515, a notification may be generated that provides an indication of the event and multiple responses performable by the autonomous tractor system in response to the event. In some embodiments, one or more of the multiple responses provided in the notification may be selected based on the unexpected event experienced by the autonomous tractor system. In these and other embodiments, one or more of the multiple responses provided in the notification may be the same regardless of the unexpected event experienced by the autonomous tractor system. Alternately or additionally, one or more of the multiple responses provided in the notification may be selected based on the agricultural task being performed by the autonomous tractor system.

At block 520, the notification may be directed to another device. In some embodiments, the notification is directed in real-time while the autonomous tractor system is performing the agricultural task.

At block 525, an answer to the notification may be obtained from the other device. In some embodiments, the answer may include a selected one of the multiple responses. At block 530, the selected one of the plurality of responses may be implemented by the autonomous tractor system while performing the agricultural task.

Modifications, additions, or omissions may be made to the method 500 without departing from the scope of the present disclosure. For example, although illustrated as discrete blocks, various blocks of the method 500 may be divided into additional blocks, combined into fewer blocks, or eliminated, depending on the desired implementation.

FIG. 6 illustrates an example computing system 600 that may be used for an operator directed autonomous system, in accordance with at least one embodiment of the present disclosure. The computing system 600 may be configured to implement or direct one or more operations associated with an operator directed autonomous system, which may include operation of the operator system 110, the autonomous tractor system 120 and/or the remote system 130 and/or the associated operations thereof. The computing system 600 may include a processor 602, memory 604, data storage 606, and a communication unit 608, which all may be communicatively coupled. In some embodiments, the computing system 600 may be part of any of the systems or devices described in this disclosure.

For example, the computing system 600 may be configured to perform one or more of the tasks described above with respect to the operator system 110, the autonomous tractor system 120, the remote system 130, and/or the methods 300, 400, or 500.

The processor 602 may include any computing entity, or processing device including various computer hardware or software modules and may be configured to execute instructions stored on any applicable computer-readable storage media. For example, the processor 602 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 602 may include any number of processors distributed across any number of networks or physical locations that are configured to perform individually or collectively any number of operations described herein.

In some embodiments, the processor 602 may be configured to interpret and/or execute program instructions and/or process data stored in the memory 604, the data storage 606, or the memory 604 and the data storage 606. In some embodiments, the processor 602 may fetch program instructions from the data storage 606 and load the program instructions in the memory 604. After the program instructions are loaded into memory 604, the processor 602 may execute the program instructions.

For example, in some embodiments, the processor 602 may be configured to interpret and/or execute program instructions and/or process data stored in the memory 604, the data storage 606, or the memory 604 and the data storage 606. The program instruction and/or data may be related to an operator directed autonomous system such that the computing system 600 may perform or direct the performance of the operations associated therewith as directed by the instructions. In these and other embodiments, the instructions may be used to perform the methods 300, 400, and/or 500 of FIGS. 3, 4, and 5.

The memory 604 and the data storage 606 may include computer-readable storage media or one or more computer-readable storage mediums for carrying or having computer-executable instructions or data structures stored thereon. Such computer-readable storage media may be any available media that may be accessed by a computer, such as the processor 602.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 602 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 608 may include any component, device, system, or combination thereof that is configured to transmit or receive information over a network. In some embodiments, the communication unit 608 may communicate with other devices at other locations, the same location, or even other components within the same system. For example, the communication unit 608 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 608 may permit data to be exchanged with a network and/or any other devices or systems described in the present disclosure.

Modifications, additions, or omissions may be made to the computing system 600 without departing from the scope of the present disclosure. For example, in some embodiments, the computing system 600 may include any number of other components that may not be explicitly illustrated or described. Further, depending on certain implementations, the computing system 600 may not include one or more of the components illustrated and described.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining operational instructions for operation of an autonomous tractor system to perform an agricultural task within an operational environment;
directing the operational instructions to the autonomous tractor system;
while the autonomous tractor system is autonomously performing the agricultural task per the operational instructions, obtaining a notification that the autonomous tractor system is experiencing an unexpected event, the notification providing an indication of the event and a plurality of responses performable by the autonomous tractor system in response to the event;
in response to the notification, obtaining, based on input from a user, a selection of one of the plurality of responses; and
directing the selected one of the plurality of responses to the autonomous tractor system.

2. The method of claim 1, wherein one or more of the plurality of responses provided in the notification are selected based on the unexpected event experienced by the autonomous tractor system.

3. The method of claim 2, wherein one or more of the plurality of responses provided in the notification are the same regardless of the unexpected event experienced by the autonomous tractor system.

4. The method of claim 1, wherein one or more of the plurality of responses provided in the notification are selected based on the agricultural task being performed by the autonomous tractor system.

5. The method of claim 1, wherein the notification is obtained in real-time while the autonomous tractor system is performing the agricultural task.

6. The method of claim 1, wherein the notification includes an image captured by autonomous tractor system that relates to the unexpected event.

7. The method of claim 1, wherein the user is separate from the autonomous tractor system such that the user cannot see or interact directly with the autonomous tractor system.

8. One or more computer readable media configured to store instructions, which when executed, are configured to cause performance of the method of claim 1.

9. A device comprising:
a user interface configured to present information to a user and to obtain input from the user;
one or more computer readable media configured to store instructions; and
a processor coupled to the computer readable media and the user interface, the processor configured to execute the instructions to cause or direct the device to perform operations, the operations comprising:
obtain, via the user interface, operational instructions for operation of an autonomous tractor system to perform an agricultural task within an operational environment;
direct the operational instructions to the autonomous tractor system over a network;
while the autonomous tractor system is autonomously performing the agricultural task per the operational instructions, obtaining, via the network, a notification that the autonomous tractor system is experiencing an unexpected event, the notification providing an indication of the event and a plurality of responses performable by the autonomous tractor system in response to the event;
present the notification via the user interface;
in response to the notification, obtaining, via the user interface, a selection of one of the plurality of responses; and
directing the selected one of the plurality of responses to the autonomous tractor system via the network.

10. The device of claim 9, wherein one or more of the plurality of responses provided in the notification are selected based on the unexpected event experienced by the autonomous tractor system.

11. The device of claim 10, wherein one or more of the plurality of responses provided in the notification are the same regardless of the unexpected event experienced by the autonomous tractor system.

12. The device of claim 9, wherein one or more of the plurality of responses provided in the notification are selected based on the agricultural task being performed by the autonomous tractor system.

13. The device of claim 9, wherein the notification is obtained in real-time while the autonomous tractor system is performing the agricultural task.

14. The device of claim 9, wherein the notification includes an image captured by autonomous tractor system that relates to the unexpected event and the image is presented via the user interface.

15. The device of claim 9, wherein the user is separate from the autonomous tractor system such that the user cannot see or interact directly with the autonomous tractor system.

16. A method comprising:
obtaining, at autonomous tractor system, operational instructions to autonomously perform an agricultural task within an operational environment;
while the autonomous tractor system is autonomously performing the agricultural task per the operational instructions, identifying an unexpected event;
generating a notification that provides an indication of the event and a plurality of responses performable by the autonomous tractor system in response to the event;
directing the notification to another device;
obtaining an answer to the notification from the other device, the answer including a selected one of the plurality of responses; and
implementing the selected one of the plurality of responses while performing the agricultural task.

17. The method of claim 16, wherein one or more of the plurality of responses provided in the notification are selected based on the unexpected event experienced by the autonomous tractor system.

18. The method of claim 17, wherein one or more of the plurality of responses provided in the notification are the same regardless of the unexpected event experienced by the autonomous tractor system.

19. The method of claim 16, wherein one or more of the plurality of responses provided in the notification are selected based on the agricultural task being performed by the autonomous tractor system.

20. The method of claim 16, wherein the notification is provided in real-time while the autonomous tractor system is performing the agricultural task.
